(19) United States
(12) Patent Application Publication
(10) Pub. No.: US 2006/0272309 A1
(43) Pub. Date: Dec. 7, 2006

(54) Collection system

(75) Inventor: Nickolas T. Moore, Beatrice, NE (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Electrolux Professional Outdoor Products, Inc., Cleveland, OH (US)

(21) Appl. No.: 11/144,297

(22) Filed: Jun. 3, 2005

(51) Int. Cl. A01D 43/06

(52) U.S. Cl. 56/202

(57) ABSTRACT

The invention provides a collection system for containing grass clippings cut by a lawn mower. The collection system comprises a hopper and at least one door. The hopper comprises at least one wall defining a perimeter of the hopper. The wall has an upper portion and a lower portion. The hopper is disposed to receive the grass clippings and contain the grass clippings. The door is disposed near the lower portion of the wall to support at least some of the grass clippings. Additionally, the door is movable from a closed position to an open position by raising the entire door such that at least some of the grass clippings are emptied from the hopper. Because the door is raised when emptying the hopper, the operator of the mower may drive the mower away from the disposal site with the door open and avoid disturbing the pile of grass clippings.

### FIELD OF THE INVENTION

The invention pertains to a collection system for a riding lawn mower, and more particularly, to a collection system that permits the dumping of the contents of the collection system.

### BACKGROUND OF THE INVENTION

Collection systems for riding lawn mowers are generally known in the art. They are typically disposed near the rear of a riding lawn mower, and they are used to collect grass clippings after they have been cut by the riding mower. Oftentimes, the grass clippings are accumulated in one or more bags. The bags include an open top portion that receives the grass clippings. When the bag becomes full, a user must lift the bag to remove it from the collection system and carry the bag to the grass disposal site. To empty the contents of the bag, the user must then lift the bottom end of the bag to tip the top portion towards the ground. Although bags are suitable for some applications, bags become less suitable for other applications, such as collecting grass over large scale cutting areas. These bags are typically heavy when loaded with grass and can be difficult to carry and empty for certain individuals. Cutting larger areas requires more frequent emptying of the bags, which results in even greater effort by the operator. Furthermore, significant time is expended for the operator to walk to the rear of the mower, remove the bag, move the bag to the dumping location, dump the contents of the bag, reattach the bag, and finally, return to the seat of the mower. Even for individuals that are able to lift a loaded bag relatively easily, an individual will still tire out from the energy required to frequently empty the bags.

In comparison, certain mowers utilize a collection system capable of dumping its contents. Dumping collection systems typically comprise a hopper that holds the grass clippings after they have been cut. These types of collection systems permit a user to position the riding mower such that the collection system is disposed above a desired dumping area. The user may then activate a mechanism to dump the clippings. Although there are certain advantages of a dumping system over a bag system, one problem with current dumping collection systems is that the hopper is maintained relatively high above the ground. The problem with having a collection system that is disposed relatively high above the ground is that it raises the center of gravity for the entire mower and, thus, creates a possibility of tipping the riding mower when cutting on a hill or other uneven surface. Similar to bag systems, these types of collection systems also typically require a user to leave the seat of the riding mower to actuate the dumping mechanism.

Many dumping collection systems dump the contents of the hopper from the bottom of the collection system. The hopper must be maintained relatively high above the ground because after dumping takes place and a pile of grass clippings are on the ground, there must be sufficient clearance between the bottom of the collection system and the pile of grass on the ground. If there is not sufficient clearance, then the pile of grass will be knocked over as the riding mower is driven away from the dumping location.

Certain other dumping collection systems are similarly disposed relatively high above the ground and have additional problems. For example, dumping is accomplished by a complicated mechanism that lifts and rotates the hopper to empty the contents of the hopper. These collection systems require a large number of interacting parts, which increases the potential for maintenance problems and the need for repairs.

Therefore, there is a need for a collection system that addresses these problems in current collection systems.

### BRIEF SUMMARY OF THE INVENTION

The invention provides a collection system that permits a user to dump the contents of a hopper with little effort by the user and without leaving the seat of the riding mower, maintains a low center of gravity to resist tipping during both normal operation and dumping, permits an operator to dump the grass clippings and drive the mower away from the dumping site without disturbing the grass pile, and has a relatively small number of moving parts to minimize the need for repair and maintenance.

The invention further provides a collection system for a riding mower that permits a user to dump grass clippings at a desired location without leaving the seat of the riding lawn mower. The collection system is mounted to the rear of the riding mower and is disposed such that the mower maintains a relatively low center of gravity. The collection system comprises a hood assembly, a hopper assembly, and a dumping assembly. The hood assembly is pivotably attached to the hopper assembly and has a receiving portion for receiving grass clippings. The hopper assembly contains the grass clippings until they are dumped. The hopper assembly comprises a wall defining a perimeter of the hopper assembly, a forward door, and a rear door. Both doors are disposed near the bottom of the wall and are movable to an open position to allow the grass clippings to be emptied from the collection system. The forward door is pivotably attached to the wall and disposed near the front of the collection system. The rear door is disposed near the rear of the collection system, and the entire rear door rises to an open position to permit grass clippings to fall out of the collection system. Considering the relatively close proximity of the collection system to the ground, having a rear door that rises from the closed position to the open position permits a user to drive the mower away from a pile of grass without disturbing the pile of grass. The dumping assembly comprises a handle and linkage assembly connected to the doors that permits the user to open the doors without leaving the seat of the riding mower.

The invention further provides a collection system for containing grass clippings cut by a lawn mower. The collection system comprises a hopper having at least one wall defining a perimeter of the hopper. The at least one wall has an upper portion and a lower portion. The collection system also comprises a door disposed near the lower portion when in a closed position. The door is movable from the closed position to an open position such that the door is moveable to the open position by raising the entire door.

The invention further provides a riding lawn mower for cutting grass. The riding lawn mower comprises a cutting deck, a hose, and a hopper. The hose has a first end and a second end. The first end is disposed to receive grass clippings from the cutting deck. The collection system is disposed to receive grass clippings from the second end of the hose. The collection system comprises a hopper, and the hopper comprises at least one wall defining a perimeter of the hopper. The at least one wall has an upper portion and a lower portion. The collection system further comprises a door disposed near the lower portion when in a closed position. The door is movable from the closed position to an open position such that the door is moveable to the open position by raising the entire door.

The invention further provides a collection system for containing grass clippings cut by a lawn mower. The collection system comprises a hopper and a door. The hopper comprises at least one wall defining a perimeter of the hopper. The at least one wall has an upper portion and a lower portion. The door is disposed near the lower portion when in a closed position such that the entire door defines at least a portion of a bottom of the collection system, and the door is movable from the closed position to an open position.

The invention further provides a collection system for containing grass clippings cut by a lawn mower. The collection system comprises a hopper, a forward door, and a rear door. The hopper comprises a forward wall and a rear wall. The forward door is disposed near a lower portion of the forward wall when in a forward door closed position. The forward door is movable from the forward door closed position to a forward door open position. The rear door is disposed near a lower portion of the rear wall when in a rear door closed position. The rear door is movable from the rear door closed position to a rear door open position.

The invention further provides a method of emptying grass clippings from a collection system attached to a riding mower. The collection system comprises a handle and a door. The door is disposed near a lower portion of the collection system when in a closed position. In the closed position the door supports at least some of the grass clippings and in an open position, at least some of the grass clippings exit from the collection system. The method comprises maneuvering the riding mower to a disposal location, moving the handle from a first position to a second position such that as the handle is moved from the first position to the second position, the entire door is raised from the closed position to the open position, and driving the riding mower away from the disposal location with the door in the open position providing clearance above the grass clippings such that the grass clippings are not disturbed.

### BRIEF DESCRIPTION OF THE DRAWINGS

FIG. 1 is a perspective view of a riding lawn mower with a collection system attached thereto.

FIG. 2 is a perspective view of a riding lawn mower chassis attached to a hitch.

FIG. 3 is an exploded perspective view of the riding lawn mower chassis and hitch of FIG. 2.

FIG. 4 is a perspective view from the front of the collection system of FIG. 1.

FIG. 5 is an elevational front view of the collection system of FIG. 1.

FIG. 6 is a bottom view of the collection system of FIG. 1.

FIG. 7 is an elevational side view of the collection system of FIG. 1.

FIG. 8 is a perspective view of a collection system door for the collection system of FIG. 1.

FIG. 9 is a perspective view of another collection system door for the collection system of FIG. 1.

FIG. 10 is a perspective view from the front of the collection system of FIG. 1 in the open position.

FIG. 11 is a perspective view from the rear of the collection system of FIG. 1 in the open position.

FIG. 12 is an elevational side view showing the collection system of FIG. 1 with the collection system doors in both the open and closed position.

FIG. 13 is an elevational side view of the collection system of FIG. 1 attached to the mower of FIG. 1 with the collection system doors in the dumping position and a pile of grass on the ground.

FIG. 14 is an elevational side view of another embodiment of a handle assembly for the collection system of FIG. 1.

FIG. 15 is a perspective view of a lock plate for the handle assembly of FIG. 14.

### DETAILED DESCRIPTION OF THE INVENTION

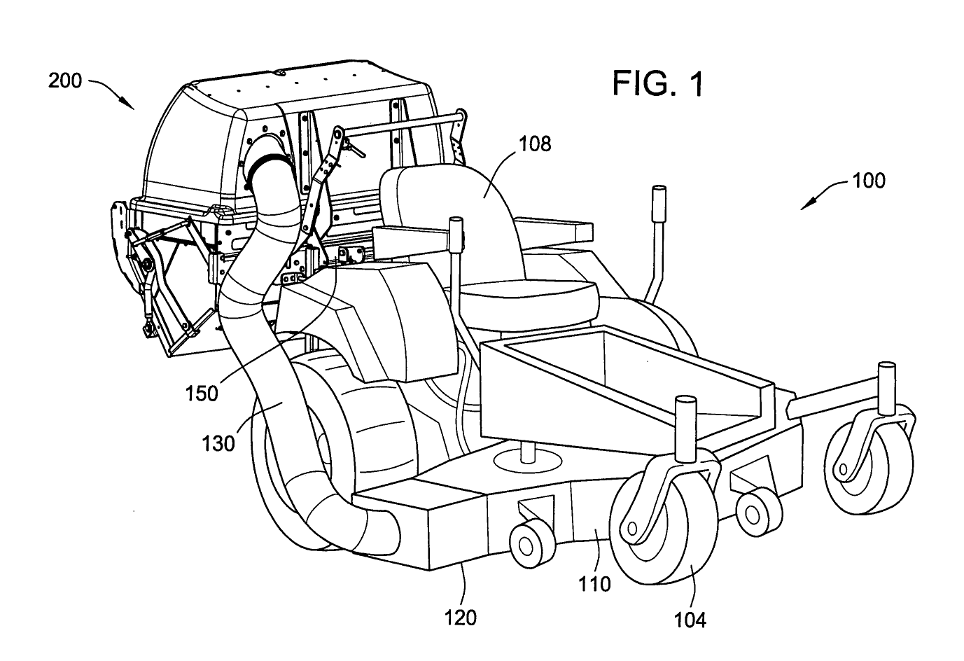

Turning to the figures, there is shown in FIG. 1, a riding lawn mower 100 with a grass collection system 200 mounted thereto. The riding mower 100 has a cutting deck 110 that includes one or more cutting blades (not shown) that are used to trim blades of grass. The mower may also include wheels 104, a motor 106 and a seat 108. A blower assembly 120 is mounted on the cutting deck 110 such that as grass is discharged out of the cutting deck 110, the grass passes into the blower assembly 120. The blower assembly 120 has an internal impeller. The grass exits out of the rear of the blower assembly 120 into a hose 130. The grass is forced up the hose 130 from the air flow that is created from the impeller and the deck 110. As the grass exits the hose 130, it is dispersed into the collection system 200. The blower may be located at another position along the hose 130. For example, the blower may be located near the collection system 200.

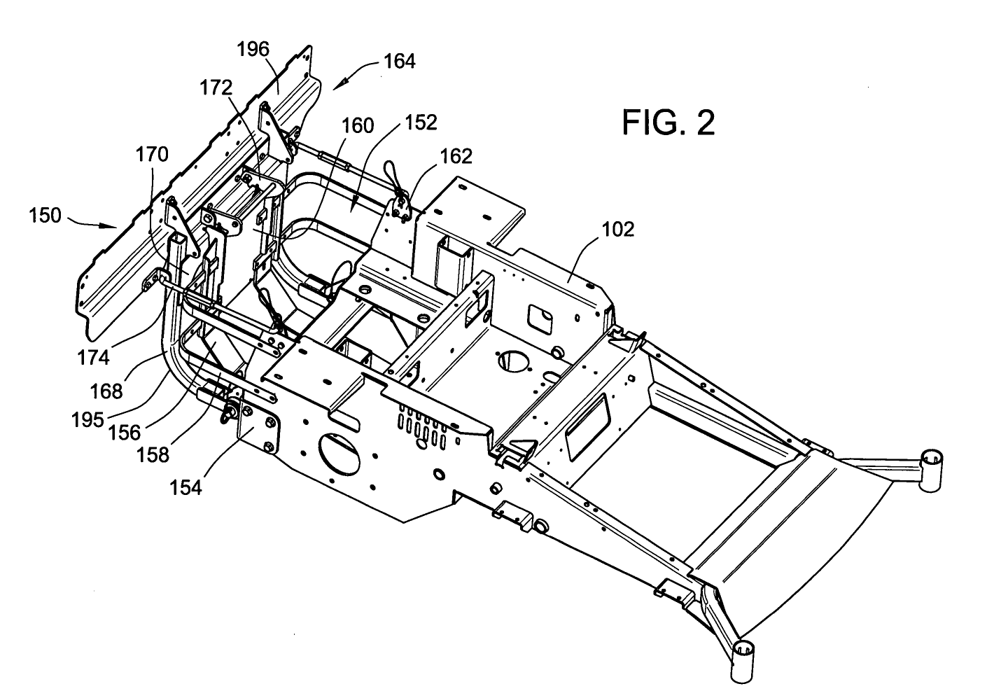

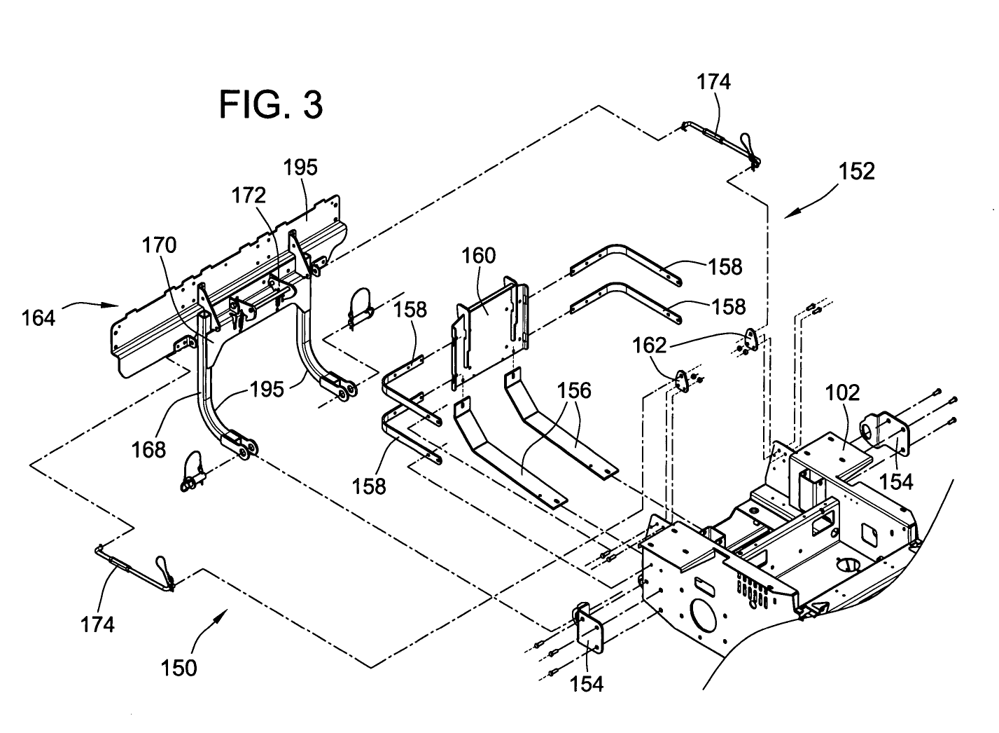

A hitch assembly 150 is used to mount the collection system 200 to the rear of the mower 100. An example of a suitable hitch assembly 150 that may be utilized with the collection system 200 is shown in FIGS. 2 and 3, and is described in more detail in U.S. patent application Ser. No. ______, (LVM Matter No. 235459, Express Mail EV420403000US) filed Jun. 3, 2005, and entitled “MOUNTING HITCH,” inventor Nickolas T. Moore, which is incorporated by reference in its entirety herein. The hitch assembly 150 comprises hitch attachment portions 152 that are directly connected to the riding mower 100 (at the riding mower chassis 102, for example) and a removably attachable portion 164 that attaches to the riding lawn mower 100 via the hitch attachment portions 152. The hitch attachment portions 152 may be individual components that may be connected to the riding mower 100, or they may be constructed as part of the riding mower 100. The hitch attachment portions 152 comprise one or more hitch brackets 154, one or more skid plates 156, one or more support straps 158, a rear guard 160, and one or more support brackets 162.

The removably attachable portion 164 is designed to be relatively simple for a single individual to attach and detach. Thus, the operator can readily attach a collection system 200 when collecting grass and similarly, detach a collection system 200 when mulching or leaving grass clippings on the lawn. The removably attachable portion 164 may comprise a hitch weldment 168, a latch 172, and one or more adjustable linkages 174. The hitch weldment may comprise a support plate 170 and one or more substantially L-shaped members 195. Further, the hitch weldment 168 may be attached to a main support member 196 for an accessory. The main support member 196, if provided, may be any suitable shape or size. Although only the above described hitch assembly embodiment is shown in the figures, any suitable structure may be utilized to attach the collection system 200 to a riding mower 100 such that the collection system 200 can receive grass that has been cut by the riding mower 100.

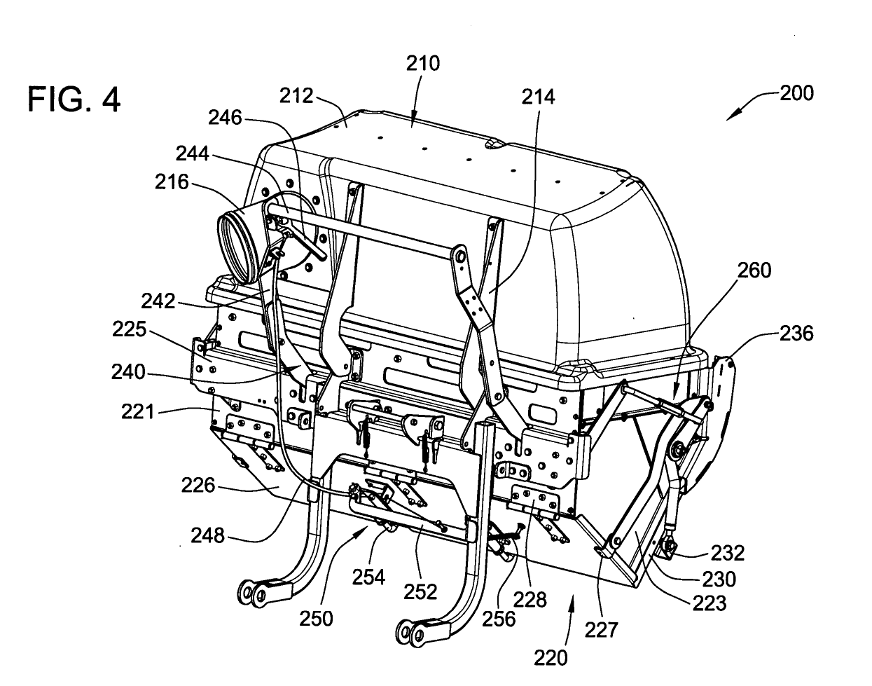

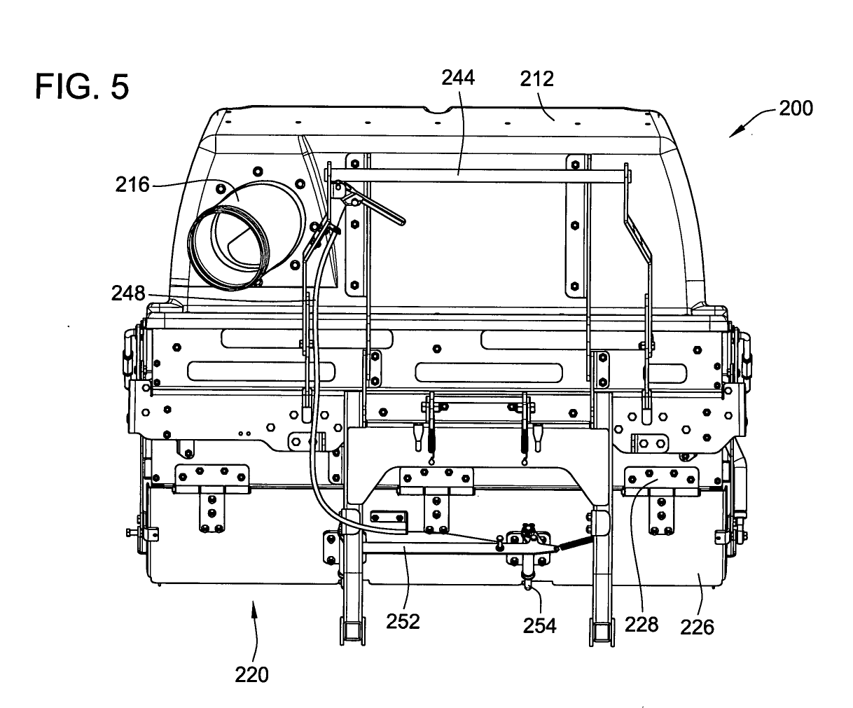

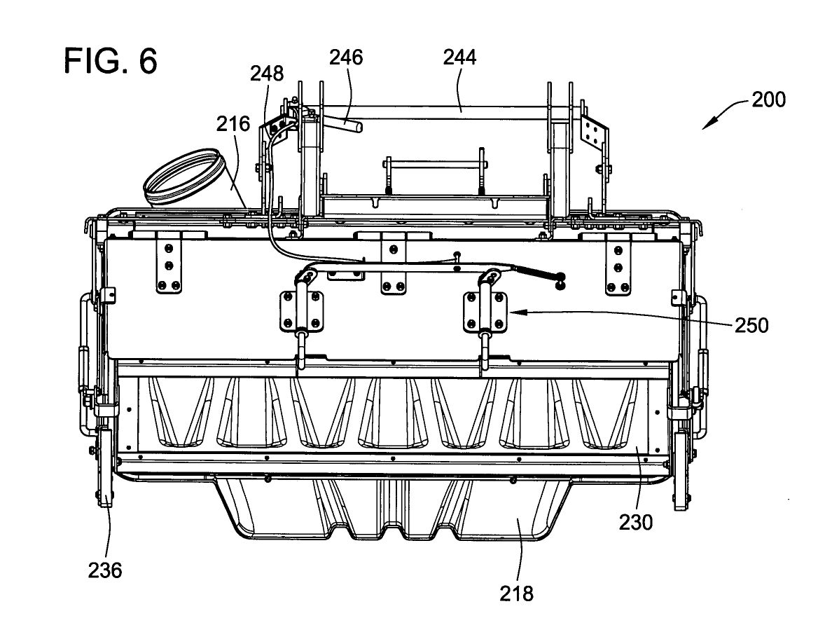

Referring to FIGS. 4-7, there is shown a collection system 200. Among other features, the collection system 200 has a structure that permits an operator to unload the contents of a hopper 220 with little effort by the operator and without the operator needing to leaving the seat 140 of the riding mower 100. The collection system 200 maintains a low center of gravity to prevent tipping during both normal operation and emptying. The collection system 200 permits an operator to dump the grass clippings and drive the mower 100 away from the dumping site without disturbing the grass pile. Furthermore, the collection system 200 may operate using a relatively small number of moving parts to minimize the need for repair and maintenance.

The collection system comprises a hood assembly 210, a hopper assembly 220, and a dumping actuation assembly 240. The hood assembly 210 is designed to direct grass and air entering into the collection system 200 rearward and downward, and is hinged to allow for internal cleanout and/or maintenance. The hopper assembly 220 is designed to retain the grass until it is ready to be dumped. The dumping actuation assembly 240 releases the grass from the hopper assembly 220.

The hood assembly 210 comprises a hood 212, hood hinge 214, a hose receiving portion 216, and a ventilation portion 218. The hood 212 provides a cover over the hopper assembly 220. The hood hinge 214 pivotably attaches the hood 212 to the hopper assembly 220 and permits access to the hopper assembly 220 from above by pivoting the hood assembly 220 up and toward the rear of the riding mower 100. In addition to being pivotably attached via the hood hinge 214, the hood assembly 210 may also be secured to the hopper assembly 220 by any suitable structure such that an operator can engage the structure to prevent inadvertent opening of the hood 212 and disengage the structure to open the hood 212.

The hose receiving portion 216 is attached to the hose 130 and serves as an inlet for grass clippings into the hopper assembly 220. Along with grass clippings, a relatively large amount of air from the blower assembly 120 also enters the collection system 200. The hood assembly 210 has a ventilation portion 218 having a structure that allows air, but not grass clippings, to easily escape from underneath the hood 212. The ventilation portion 218 is disposed near the rear of the hood 212 and is generally arcuately shaped. The lower portion of the ventilation portion 218 extends beyond a rear wall 222 of the hopper assembly 220. As air and grass enter through the hose receiving portion 216, the weight of the grass causes it to fall into the hopper assembly 220 while the air is directed downward by the arcuately shaped ventilation portion 218. The air exits through the space between the ventilation portion 218 and the rear wall of the hopper assembly 220. The hood may be any suitable shape and/or size, and may include any suitable feature to permit the ventilation of air from inside the collection system 200 to outside the collection system 200.

The hopper assembly 220 comprises one or more walls, such as a front wall 221, rear wall 222, and side walls 223, 224, a forward door 226, and a rear door 230. The walls 221, 222, 223, 224 form the perimeter of the hopper assembly 220 and support the sides of a pile of grass in the hopper assembly 220. The hopper assembly 220 may be any suitable shape or size such that the hopper assembly 220 can retain grass clippings. Additionally, the hopper assembly 220 may have a support plate 225 attached to the front wall 221 that may be used, for example, to connect to the hitch assembly 150.

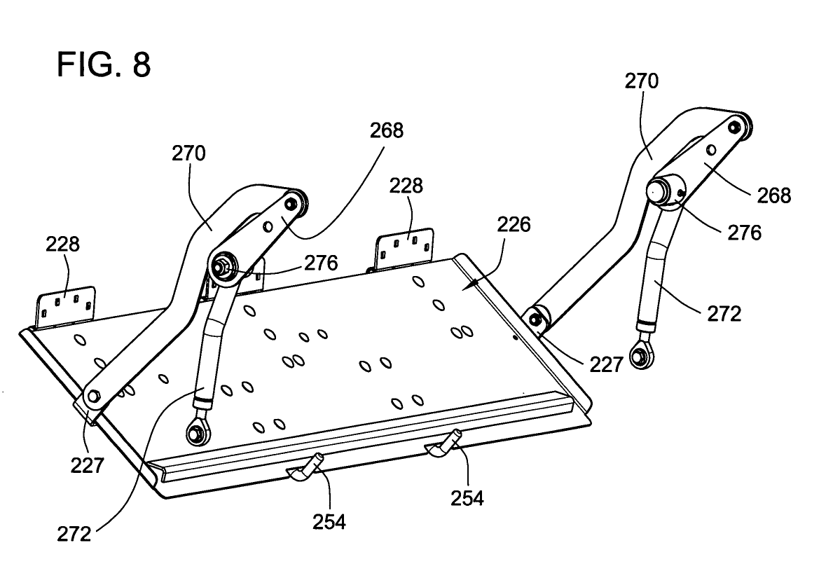

As shown in FIG. 8, the forward door 226 has a structure that is suitable for pivoting with respect to the hopper 220 and for receiving one or more forward door lift arms 270 for exerting a force on the forward door 226 to open the door 226. The forward door 226 may comprise, for example, one or more lift tabs 227 and one or more hinges 228. The hinges 228 may be mounted near the top and front of the forward door 226 such that the forward door 226 is pivotably connected to the front and lower portion of the hopper assembly front wall 221.

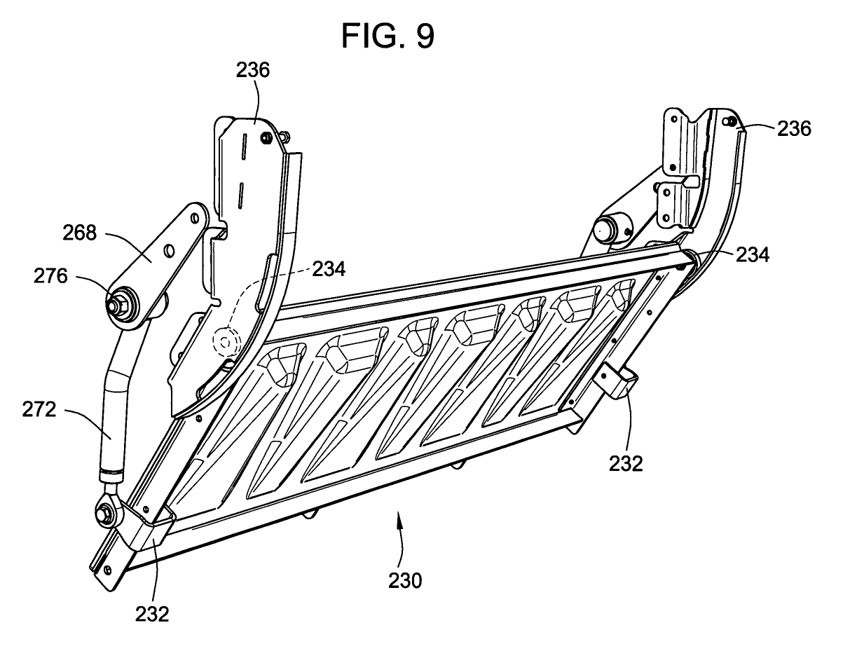

Referring to FIG. 9, the rear door 230 may comprise a structure and/or be connected to components that permit the rear door 230 to be moved between a closed position and an open position. The rear door 230 may comprise one or more lift tabs 232 and one or more roller bearings 234. A track 236 is disposed at each side of the hopper assembly 220. The tracks 236 enable the rear door 230 to be raised to the open position and release grass from the hopper assembly 220. The roller bearings 234 are disposed within these tracks 236 such that the rear door 230 is movable within the tracks 236 and raisable from a closed position to an open position.

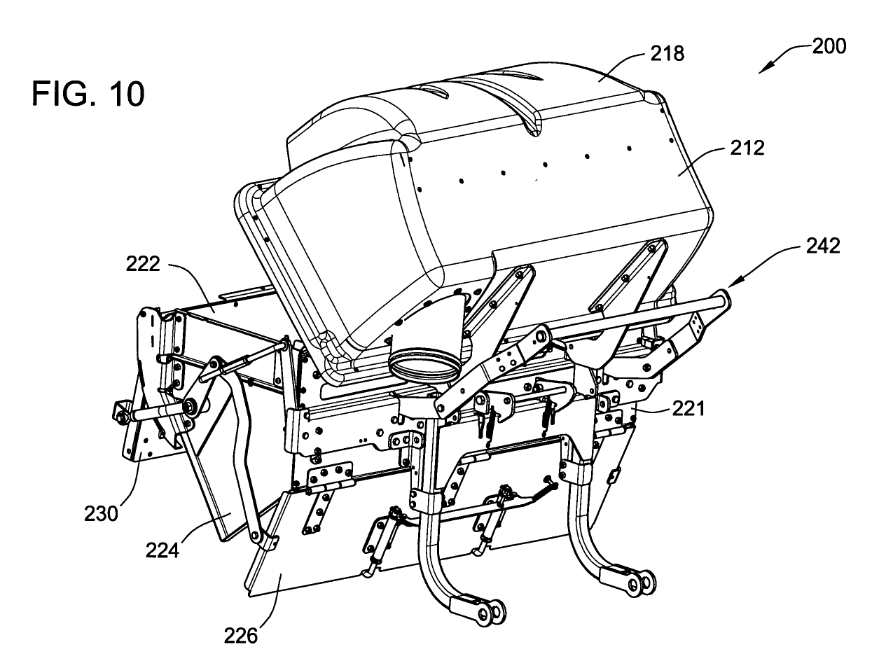

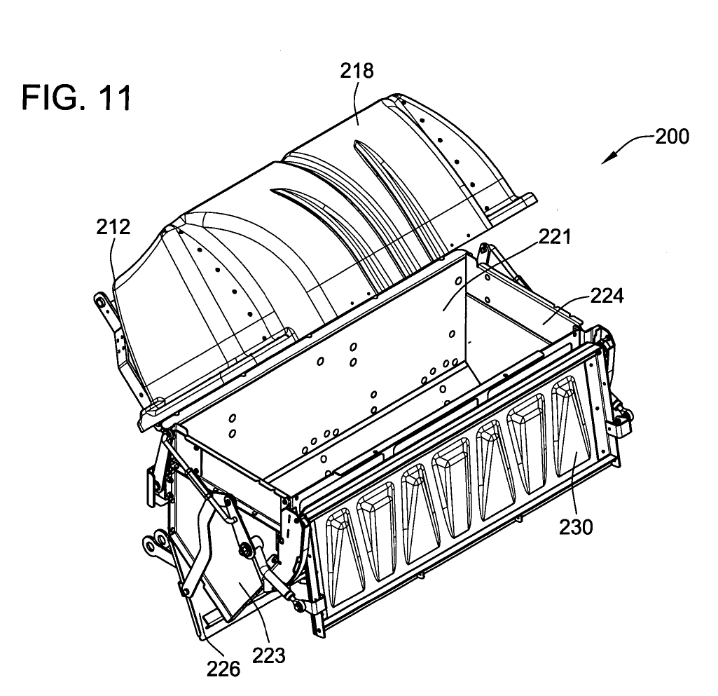

Turning back to FIGS. 4-7, the dumping actuation assembly 240 comprises a structure suitable for maneuvering the forward door 226 and the rear door 230 between an open and closed position when a user operates the dumping actuation assembly 240 (see FIGS. 10 and 11 for examples of the collection system with the doors 226, 230 and hood 212 in the open position). The dumping actuation assembly 240 may comprise a handle assembly 242, a latch assembly 250, and a linkage assembly 260. The handle assembly 242 is connected to and activates both the linkage assembly 260 and the latch assembly 250. The latch assembly 250 prevents the forward door 226 and rear door 230 from separating when bearing the weight of the grass clippings and also prevents the handle 244 from moving and unintentionally opening the doors 226, 230. The linkage assembly 260 opens and closes the forward door 226 and the rear door 230 when an operator moves the handle 244.

As mentioned above, the operation of the collection system 200 is such that an operator can open and close the doors 226, 230 without leaving the seat of the mower 100. The handle assembly 242 is pivotably attached to the front wall 221 of the hopper 220 and comprises a handle 244. A grip 246 may be attached to the handle assembly 242. The grip 246 is also connected to a cable 248 attached to a latch strap 252. The latch strap 252 is part of the latch assembly 250 and is connected to one or more latch pins 254. The latch pins 254 are L-shaped members that are disposed near the intersection of the forward door 226 and the rear door 230, and prevent the forward door 226 and rear door 230 from separating under the weight of the grass in the hopper 220 and leaking grass. When the latch strap 252 is laterally moved by the cable 248, the latch pins 254 rotate. After being rotated a certain distance, the latch pins 254 no longer engage the doors 226, 230 and thus, permit the separation of the forward door 226 from the rear door 230. A tension spring 256 may be attached to the latch strap 252 to help retain the latch pins 254 in the locked position. It should be noted, however, that any suitable latch assembly 250 may be utilized such that the doors are restrained from unintended separation and/or the handle is prevented from unintentionally moving and opening the doors 226, 230.

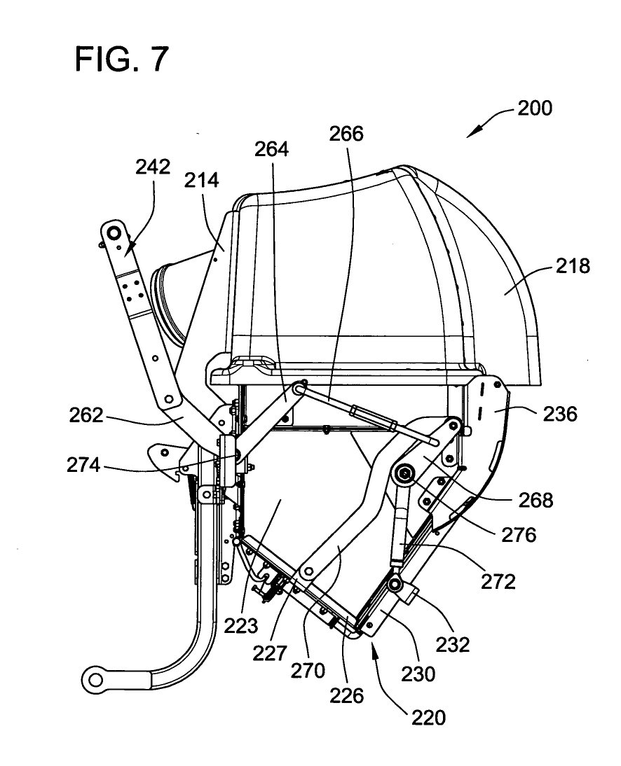

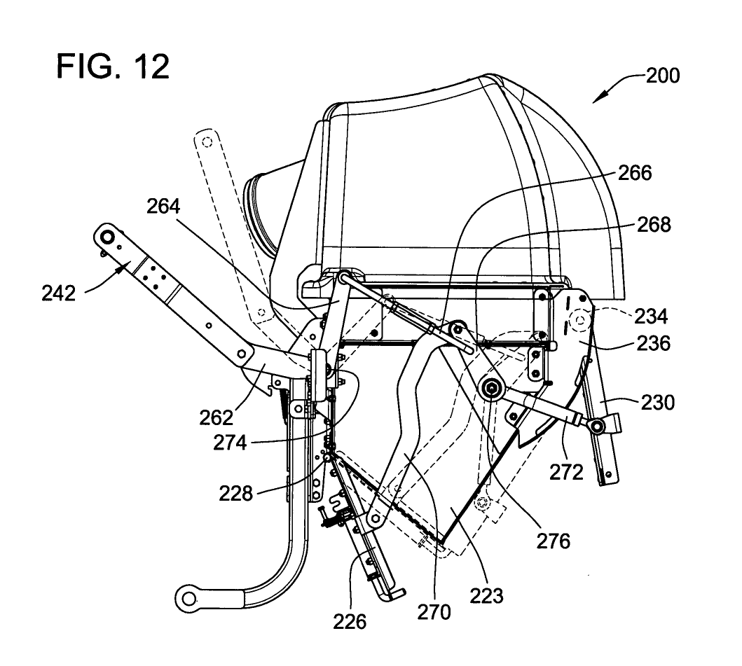

Referring to FIG. 12, the linkage assembly 260 comprises a plurality of links 262, 264, 266, 268, 270, 272 and a shaft 274 that allow an operator to open and close the forward door 226 and rear door 230 by moving the handle 244. FIG. 12 shows a comparison of these components of the collection system 200 in both the open and the closed positions. Referring to FIG. 4, when the grip 246 is squeezed toward the handle 244, the cable 248 pulls on the latch strap 252 to disengage the latch pins 254, and the operator can pull down on the handle 244. Referring to FIGS. 7 and 12, moving the handle 244 causes the handle link 262, which is fixed to the handle assembly 242, to rotate a cross shaft 274. At each end of the cross shaft 274, there is a link arm 264. The link arms 264 are attached to adjustable links 266, which are connected to link 268. The link 268 is attached to a forward door lift arm 270 and a rear door lift arm 272. The rear door lift arms 272 are fixed to the links 268, and the links 268 and rear door lift arms 272 are pivotal around a bushings 276 that are secured to the side walls 223, 224 of the hopper 220. The forward door lift arms 270 are attached to the forward door 226 via lift tabs 227, and the rear door lift arms 272 are attached to the rear door 230 via lift tabs 232.

Referring to FIG. 12, as the handle 244 is rotated, the handle links 262 rotate the cross shaft 274. This, in turn, rotates the link arms 264, which pulls the adjustable links 266 forward. The link 268 then rotates around the bushing 276 to rotate the rear door lift arm 272 around the bushing 276 and move the forward door lift arm 270 downward and forward. The rear door 230 is swung open moving upward and to the rear. As the handle 244 is moved further, the roller bearings 234 begin to roll in the tracks 236 and the rear door 230 lifts up and to the rear. As the rear door 230 begins to open, the forward door lift arms 270 begin to push down and forward on the forward door 226. In response, the forward door 226 pivots around the forward door hinge 228 and opens downward and forward.

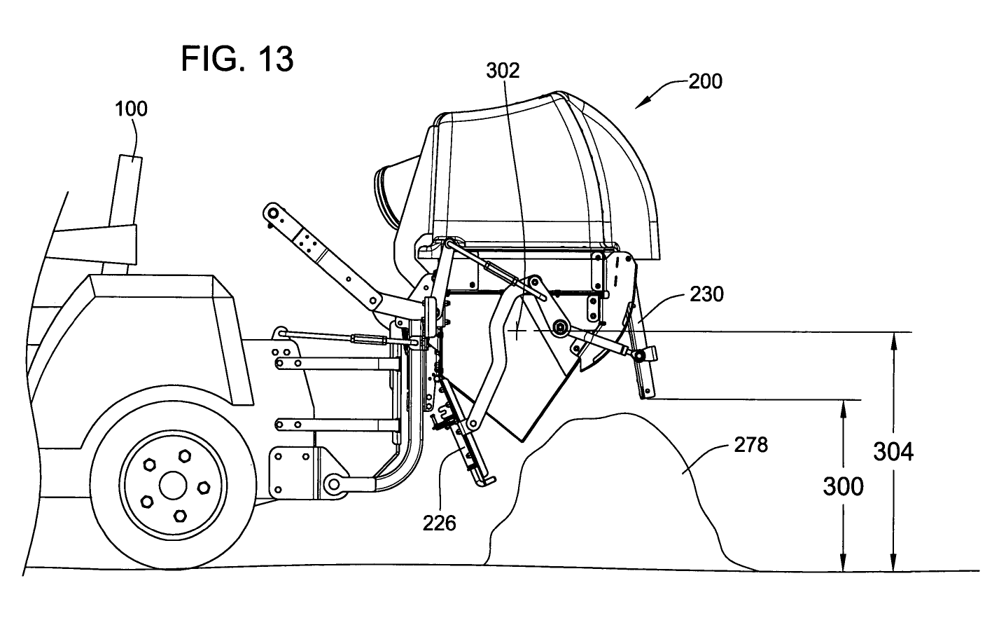

The arrangement of the dumping actuator assembly 240 and the weight of the forward door 226 help to retain the doors 226, 230 in the open position. Since the grass clippings are maintained in the hopper 220 by the forward door 226 and rear door 230 when they are in the closed position, when the doors 226, 230 are opened, the grass clippings are no longer restrained and fall to the ground by gravity as shown in FIG. 13. The operator can then pull the riding mower away from the pile of grass 278 without dragging the pile of grass 278 with the rear door 230. To close the doors 226, 230, the operator lifts the handle 244 and squeezes the grip 246. This moves the links 262, 264, 266, 268, 270, 272, shaft 274, and doors 226, 230 in a direction opposite the direction described above until the doors 226, 230 are once again adjacent to one another. The operator then releases the grip 246, and the latch pins rotate to secure the doors 226, 230 in the closed position.

The distance 300 from the bottom of the rear door to the ground may be in the range of 6 inches to 24 inches. In one embodiment, the distance 300 is approximately 14 inches. The collection system has a center of gravity 302 when the collection system is full of grass. The distance 304 of the center of gravity to the ground may be in the range of 12 inches to 48 inches. In one embodiment, the distance 304 is approximately 22 inches.

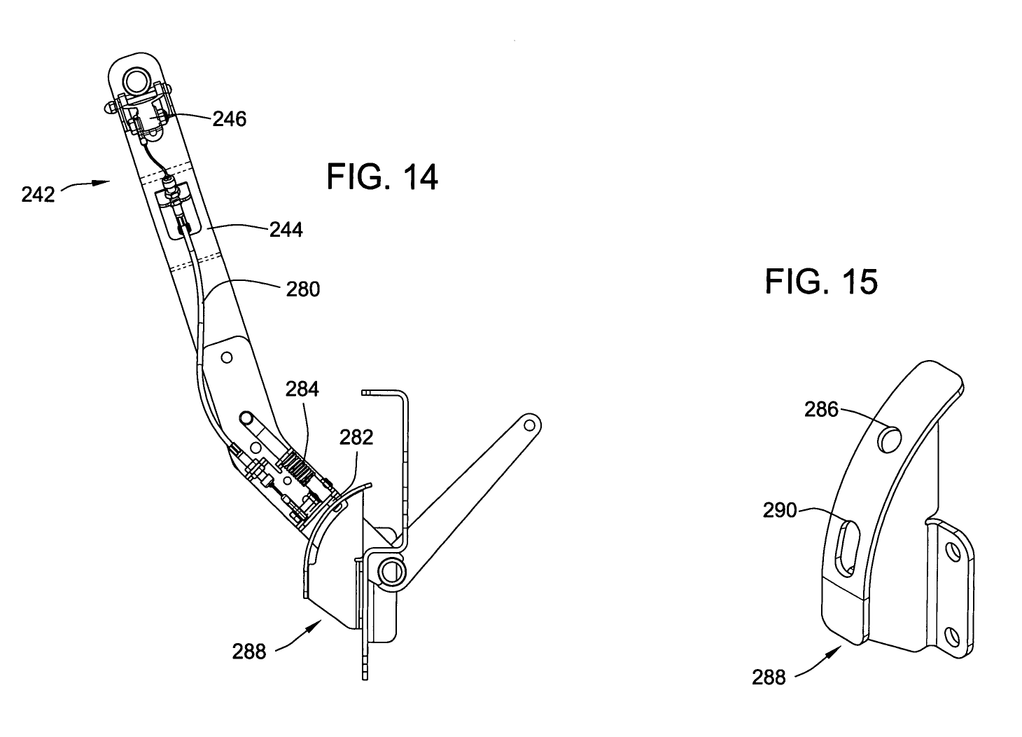

In another embodiment shown in FIGS. 14-15, the grip 246 may be connected to a cable 280 that is attached to a lock pin 282. The lock pin 282 has a tension spring 284 that forces the pin 282 into an aperture 286 in a lock plate 288. The lock plate 288 is mounted to the support plate 225 or other suitable structure. When the pin 282 is disposed within the aperture 286, the handle assembly 242 cannot be moved. The grip 246 and cable 280 operate to disengage the lock pin 282 from the aperture 286 so that the handle 244 may be moved. When the doors 226, 230 are in the fully open position, the operator can release the grip 246, which will cause the tension spring 284 to force the lock pin 282 down into another aperture 290 in the lock plate 288 to lock the doors 226, 230 in the open position. To close the doors 226, 230, the operator may squeeze the grip 246 on the handle assembly 242. The lock pin 282 will disengage from the lock plate 288 and allow the doors 226, 230 to be returned to the closed/locked position.

Although the collection system has been described for use with a riding mower, it may be used with any suitable mower.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A collection system for containing grass clippings cut by a lawn mower, the collection system comprising:
a hopper comprising at least one wall defining a perimeter of the hopper, the at least one wall having an upper portion and a lower portion; and
a door disposed near the lower portion when in a closed position, the door being movable from the closed position to an open position such that the door is moveable to the open position by raising the entire door.

2. The collection system of claim 1 further comprising a second door disposed near the lower portion, the second door being movable from a second door closed position to a second door open position.

3. The collection system of claim 2 wherein the door and the second door are adjacently disposed when the door and the second door are closed such that the door and the second door form a bottom of the collection system.

4. The collection system of claim 1 further comprising a handle for moving the door from the closed position to the open position.

5. The collection system of claim 4 further comprising a linkage assembly connected between the handle and the door.

6. The collection system of claim 1 wherein the door has a track riding portion and the collection system further comprises a track for receiving the track riding portion such that the track riding portion moves along the track when the door is raised to the open position.

7. The collection system of claim 6 wherein the track riding portion is a wheel.

8. The collection system of claim 1 further comprising a support mechanism disposed to resist movement of the door when in the closed position.

9. The collection system of claim 8 wherein the support mechanism is a latch.

10. The collection system of claim 8 wherein the support mechanism is releasable from a seat on the lawn mower.

11. The collection system of claim 1 further comprising a hitch to attach the collection system to the lawn mower.

12. The collection system of claim 1 further comprising a hood disposed near the upper portion.

13. The collection system of claim 1 wherein when the door is in the closed position and the collection system contains grass clippings, at least some of the grass clippings are supported by the door, and grass clippings exit from the collection system when the door is in the open position.

14. The collection system of claim 1 wherein the door is movable from a seat on the riding lawn mower.

15. The collection system of claim 1 wherein the entire door defines at least a portion of a bottom of the collection system.

16. A riding lawn mower for cutting grass, the riding lawn mower comprising:
a cutting deck;
a hose having a first end and a second end, the first end disposed to receive grass clippings from the cutting deck; and
a collection system disposed to receive grass clippings from the second end of the hose, the collection system comprising a hopper, the hopper comprising at least one wall defining a perimeter of the hopper, the at least one wall having an upper portion and a lower portion, and the collection system further comprising a door disposed near the lower portion when in a closed position, the door being movable from the closed position to an open position such that the door is moveable to the open position by raising the entire door.

17. A collection system for containing grass clippings cut by a lawn mower, the collection system comprising:
a hopper comprising at least one wall defining a perimeter of the hopper, the at least one wall having an upper portion and a lower portion; and
a door disposed near the lower portion when in a closed position such that the entire door defines at least a portion of a bottom of the collection system, the door being movable from the closed position to an open position.

18. The collection system of claim 17 wherein when the door is in the closed position and grass clippings are disposed within the collection system, at least some of the grass clippings are disposed on the door, and at least some of the grass clippings exit from the collection system when the door is in the open position.

19. A collection system for containing grass clippings cut by a lawn mower, the collection system comprising:
a hopper comprising a forward wall and a rear wall;
a forward door disposed near a lower portion of the forward wall when in a forward door closed position, the forward door being movable from the forward door closed position to a forward door open position; and
a rear door disposed near a lower portion of the rear wall when in a rear door closed position, the rear door being movable from the rear door closed position to a rear door open position.

20. The collection system of claim 19 wherein the forward door is pivotable.

21. The collection system of claim 19 wherein the rear door is raisable.

22. The collection system of claim 19 further comprising a support mechanism disposed to resist unintended separation of the forward door and the rear door when the forward door and the rear door are closed.

23. The collection system of claim 22 wherein the support mechanism is a latch.

24. The collection system of claim 19 wherein the forward door and the rear door are movable from a seat on the lawn mower.

25. A method of emptying grass clippings from a collection system attached to a riding mower, the collection system comprising a handle and a door, the door disposed near a lower portion of the collection system when in a closed position, whereby in the closed position the door supports at least some of the grass clippings and in an open position at least some of the grass clippings exit from the collection system, the method comprising:
maneuvering the riding mower to a disposal location;
moving the handle from a first position to a second position, the handle being connected to the door such that as the handle is moved from the first position to the second position, the entire door is raised from the closed position to the open position; and
driving the riding mower away from the disposal location, the door in the open position providing clearance above the grass clippings such that the grass clippings are not disturbed.

26. The method of claim 25 further comprising returning the handle to the first position such that the entire door is lowered into the closed position.
